(19) United States
(12) Patent Application Publication
(10) Pub. No.: US 2007/0085861 A1
(43) Pub. Date: Apr. 19, 2007

(54) Liquid crystal display with brightness detector and method for manufacturing the same

(75) Inventors: Yaw-Shing Tseng, Miao-Li (TW); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/580,448

(22) Filed: Oct. 13, 2006

(30) Foreign Application Priority Data
Oct. 14, 2005 (TW) 94135977

(51) Int. Cl. G09G 5/10

(52) U.S. Cl. 345/690

(57) ABSTRACT

A liquid crystal display (200) includes a liquid crystal panel (210) having a first substrate (211), a second substrate (212), a liquid crystal layer between the first and second substrates, and a brightness detector (214) provided at a blank edge area of the second substrate, the blank edge area having driving circuits. The present invention also provides a method for manufacturing the liquid crystal display.

### FIELD OF THE INVENTION

The present invention relates to liquid crystal displays (LCDs), and more particularly to an LCD having a brightness detector and a method for manufacturing the LCD.

### BACKGROUND

Because LCDs have the advantages of portability, low power consumption, and low radiation, they have been widely used in various portable information products such as notebooks, personal digital assistants (PDAs), video cameras, and the like. Furthermore, LCDs are considered by some to have the potential to completely replace CRT (cathode ray tube) monitors and televisions.

Brightness is an important parameter to evaluate the performance of a display of an LCD. A user may adjust the brightness of the display according to the prevailing operational environment in which he/she is viewing the display.

Referring to FIG. 4, a conventional LCD 100 includes a liquid crystal panel 110, and a backlight module 120 disposed under the liquid crystal panel 110 for illuminating the liquid crystal panel 110.

Also referring to FIG. 5, the backlight module 120 includes a light source 121, a brightness detector 122, and a control circuit 123. The brightness detector 122 detects a brightness of the ambient environment of the LCD 100, generates a corresponding photocurrent, and transmits the photocurrent to the control circuit 123. Then the control circuit 123 converts the photocurrent to a voltage signal, and adjusts the brightness of the light source 121 according to the voltage signal. Thereby, a brightness of the light beams emitted by the light source 121 corresponds with the brightness of the ambient environment. The brightness detector 122 may be a phototransistor.

The LCD 100 thus automatically adjusts the brightness of light provided by the backlight module 120 according to the brightness of the ambient environment. However, the backlight module 120 also includes other components such as a plastic frame, a metal bottom plate, and various kinds of optical films. All together, the brightness detector 122, the control circuit 123 and the other components make the backlight module 120 rather complicated and bulky. This correspondingly makes the structure of the LCD 100 unduly complicated and bulky.

Accordingly, what is needed is an LCD that can overcome the above-described deficiencies, and a method for making such LCD.

### SUMMARY

A liquid crystal display includes a liquid crystal panel having a first substrate, a second substrate, a liquid crystal layer between the first and second substrates, and a brightness detector provided at a blank edge area of the second substrate, the blank edge area having driving circuits.

A method for manufacturing a liquid crystal display includes: providing a first substrate and a second substrate; synchronously depositing an N⁻ type amorphous silicon layer at a blank edge area of the second substrate which has driving circuits and etching the N⁻ type amorphous silicon layer while forming a thin film transistor array at the second substrate; depositing an N⁺ type amorphous silicon layer on the N⁻ type amorphous silicon layer and etching the N⁺ type amorphous silicon layer such that the N⁺ type amorphous silicon layer partly overlaps the N⁻ type amorphous silicon layer; depositing an indium-tin-oxide layer on the N⁺ type amorphous silicon layer and depositing another indium-tin-oxide layer on the N⁻ type amorphous silicon layer such that said another indium-tin-oxide layer partly overlaps the N⁻ type amorphous silicon layer, in order to form a brightness detector; and filling liquid crystal material between the substrates, and assembling the substrates to form a liquid crystal panel.

Other advantages and novel features will become more apparent from the following detailed description when taken in conjunction with the accompanying drawings.

### BRIEF DESCRIPTION OF THE DRAWINGS

FIG. 1 is a schematic diagram of certain parts of an LCD according to an exemplary embodiment of the present invention, the LCD including a brightness detector.

FIG. 2 is an enlarged, side plan view of the brightness detector of FIG. 1.

FIG. 3 is a flow diagram of components of the LCD of the exemplary embodiment which are involved in a process of detecting ambient brightness and adjusting a brightness of a light source of the LCD accordingly.

FIG. 4 is a schematic, exploded side view of a conventional LCD.

FIG. 5 is a flow diagram of components of the conventional LCD which are involved in a process of detecting ambient brightness and adjusting a brightness of a light source of the LCD accordingly.

### DETAILED DESCRIPTION OF PREFERRED EMBODIMENTS

Reference will now be made to the drawings to describe the present invention in detail.

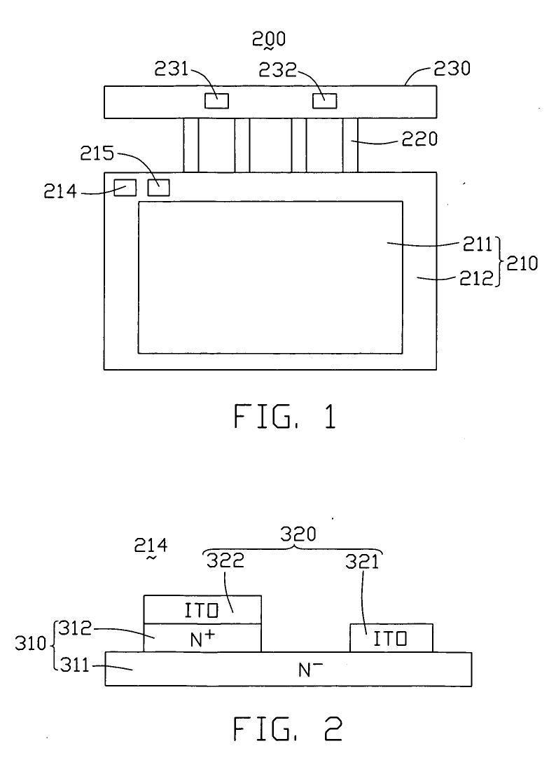

Referring to FIG. 1, this is a schematic diagram of certain parts of an LCD according to an exemplary embodiment of the present invention. The LCD 200 includes a liquid crystal panel 210, a plurality of flexible printed circuit boards 220, a printed circuit board 230, and a backlight module (not shown). The printed circuit board 230 is electrically connected with the liquid crystal panel 210 via the flexible printed circuit boards 220. The backlight module is disposed at a rear side of the liquid crystal panel 210. The liquid crystal panel 210 includes a first substrate 211, a second substrate 212, and a liquid crystal layer (not shown) disposed between the first and second substrates 211 and 212. A brightness detector 214 and a signal amplifier 215 are disposed side by side at a blank edge area of the second substrate 212. The blank edge area also has a plurality of driving circuits (not shown). The printed circuit board 230 includes an analog-to-digital converter 231 and a control circuit 232 disposed thereon.

Also referring to FIG. 2, this is an enlarged, side plan view of the brightness detector 214. The brightness detector 214 is a schottky diode, which in general includes a semiconductor layer and a conductive metal layer. In the illustrated embodiment, the semiconductor layer is an amorphous silicon layer combination 310. The amorphous silicon layer combination 310 includes an N⁻ type amorphous silicon layer 311, and an N⁺ type amorphous silicon layer 312 partly overlapped on the N⁻ type amorphous silicon layer 311. In the illustrated embodiment, the conductive metal layer is an indium-tin-oxide layer assemblage 320, which includes a first indium-tin-oxide layer 321 partly overlapped on the N⁻ type amorphous silicon layer 311, and a second indium-tin-oxide layer 322 stacked on the N⁺ type amorphous silicon layer 312.

The N⁺ type amorphous silicon layer 312 between the second indium-tin-oxide layer 322 and the N⁻ type amorphous silicon layer 311 forms a schottky barrier. Thus the N⁻ type amorphous silicon layer 311 can generate a kind of photoelectric effect when it absorbs light beams emitted by the backlight. That is, electrons in the N⁻ type amorphous silicon layer 311 can absorb energy of photons of the light beams, undergo transition to higher energy levels, and transmit to the indium-tin-oxide layer 320 that has a lower electric potential. The transmission of the electrons generates electric current, and the current is output to an outside circuit (not shown) via the second indium-tin-oxide layer 322 and the N⁻ type amorphous silicon layer 311.

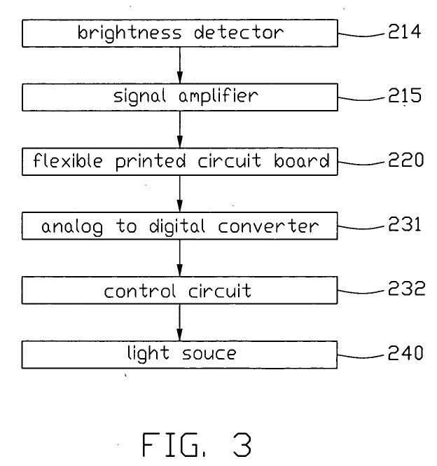

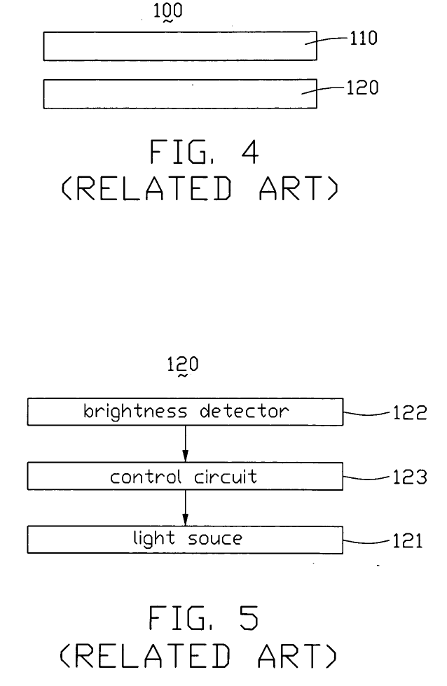

Referring to FIG. 3, this is a flow diagram of components of the LCD 200 which are involved in a process of detecting ambient brightness and adjusting a brightness of a light source 240 of the backlight module (not shown) of the LCD 200 accordingly. The brightness detector 214 detects the brightness of the ambient environment, and outputs a corresponding voltage signal to the signal amplifier 215. The signal amplifier 215 amplifies the voltage signal, and transmits the voltage signal to the printed circuit board 230 via the flexible printed circuit boards 220. The analog-to-digital converter 231 on the printed circuit board 230 receives the voltage signal, converts the voltage signal to a digital signal, and transmits the digital signal to the control circuit 232. The control circuit 232 adjusts the brightness of the light source 240 according to the received digital signal. For example, the control circuit 232 may raise or lower a current brightness of the light source 240, according to the current brightness and according to the ambient brightness as indicated by the received digital signal. Thereby, control of the brightness of the backlight module is realized.

Typically, at least one predetermined signal that corresponds to at least one reference brightness of the backlight module is configured and inputted to the control circuit 232 at the time the LCD 200 is manufactured on a production line. Thereby, the control circuit 232 can adjust the brightness of the light source 240 using the at least one reference brightness as a benchmark.

The brightness detector 214 is formed on the second substrate 212 at the time when a semiconductor layer is deposited on the second substrate 212 and a thin film transistor array is formed on the second substrate 212 by etching the semiconductor layer. This simplifies the overall process of fabricating the LCD 200, and lowers costs.

In particular, an exemplary method for manufacturing the LCD 200 includes the steps of: a) providing a first substrate 211 and a second substrate 212; b) synchronously depositing and etching an N⁻ type amorphous silicon layer 311 at a blank edge area of the second substrate 212 that has driving circuits while forming a thin film transistor array on the second substrate 212; c) depositing and etching an N⁺ type amorphous silicon layer 312 that partly overlaps the N⁻ type amorphous silicon layer 311; d) depositing a first indium-tin-oxide layer 321 that partly overlaps the N⁺ type amorphous silicon layer 311; e) depositing a second indium-tin-oxide layer 322 on the N⁺ type amorphous silicon layer 312 to form a schottky diode type brightness detector 214, whereby the second indium-tin-oxide layer 322 and the N⁻ type amorphous silicon layer 311 are configured to be electrically connected to an outside circuit (not shown); f) forming a signal amplifier 215 on the second substrate 212 adjacent to the brightness detector 214; and g) filling liquid crystal material between the substrates 211 and 212, and assembling the substrates 211 and 212 to form the liquid crystal panel 210.

After that, a plurality of flexible printed circuit boards 220 is connected with the liquid crystal panel 210. An analog-to-digital converter 231 and a control circuit 232 are arranged on a printed circuit board 230. The printed circuit board 230 is electrically connected with the liquid crystal panel 210 via the flexible printed circuit boards 220. Thus, the LCD 200 is obtained.

According to the above-described method, the brightness detector 214 is formed on the second substrate 212 while a thin film transistor array is formed on the second substrate 212 by deposition and etching. This simplifies the overall process of fabricating the LCD 200, and lowers costs.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal panel comprising:
a first substrate, a second substrate, and a liquid crystal layer between the first and second substrates; and
a brightness detector provided at a blank edge area of the second substrate, the blank edge area having driving circuits.

2. The liquid crystal display as claimed in claim 1, wherein the brightness detector comprises a schottky diode, and the schottky diode comprises at least one semiconductor layer and at least one conductive metal layer.

3. The liquid crystal display as claimed in claim 2, wherein the at least one semiconductor layer is at least one amorphous silicon layer.

4. The liquid crystal display as claimed in claim 3, wherein the at least one amorphous silicon layer comprises an N⁻ type amorphous silicon layer.

5. The liquid crystal display as claimed in claim 4, wherein the at least one amorphous silicon layer further comprises an N⁺ type amorphous silicon layer partly overlapped with the N⁻ type amorphous silicon layer.

6. The liquid crystal display as claimed in claim 5, wherein the at least one conductive metal layer is at least one indium-tin-oxide layer.

7. The liquid crystal display as claimed in claim 6, wherein the at least one indium-tin-oxide layer partly overlaps with the N⁻ type amorphous silicon layer.

8. The liquid crystal display as claimed in claim 7, wherein the at least one indium-tin-oxide layer is two indium-tin-oxide layers, one of the indium-tin-oxide layers overlaps with the N⁻ type amorphous silicon layer, and the other indium-tin-oxide layer is arranged on the N⁺ type amorphous silicon layer.

9. The liquid crystal display as claimed in claim 1, wherein the second substrate further comprises a signal amplifier provided thereat.

10. The liquid crystal display as claimed in claim 1, further comprising at least one flexible printed circuit board connecting with the liquid crystal panel.

11. The liquid crystal display as claimed in claim 10, further comprising a printed circuit board connecting with the liquid crystal panel via the at least one flexible printed circuit board.

12. The liquid crystal display as claimed in claim 11, wherein the printed circuit board comprises a signal control circuit provided thereat.

13. The liquid crystal display as claimed in claim 11, wherein the printed circuit board comprises an analog-to-digital converter provided thereat.

14. A method for manufacturing a liquid crystal display, comprising:
providing a first substrate and a second substrate;
synchronously depositing an N⁻ type amorphous silicon layer at a blank edge area of the second substrate which has driving circuits and etching the N⁻ type amorphous silicon layer while forming a thin film transistor array at the second substrate;
depositing an N⁺ type amorphous silicon layer on the N⁻ type amorphous silicon layer and etching the N⁺ type amorphous silicon layer such that the N⁺ type amorphous silicon layer partly overlaps the N⁻ type amorphous silicon layer;
depositing an indium-tin-oxide layer on the N⁺ type amorphous silicon layer and depositing another indium-tin-oxide layer on the N⁻ type amorphous silicon layer such that said another indium-tin-oxide layer partly overlaps the N⁻ type amorphous silicon layer, in order to form a brightness detector; and
filling liquid crystal material between the substrates, and assembling the substrates to form a liquid crystal panel.

15. The method as claimed as claim 14, further comprising:
providing a flexible printed circuit board, and connecting the flexible printed circuit board with the liquid crystal panel;
providing a printed circuit board:
arranging an analog-to-digital converter and a control circuit on the printed circuit board; and
electrically connecting the printed circuit board with the liquid crystal panel via the flexible printed circuit board.

16. The method as claimed as claim 14, further comprising:
arranging a signal amplifier on the blank edge area of the second substrate.

17. A liquid crystal display, comprising:
a liquid crystal panel comprising:
a first substrate, a second substrate, and a liquid crystal layer between the first and second substrates;
a backlight module located at a rear side of the liquid crystal panel; and
a brightness detector and control circuits provided on the second substrate rather than the backlight module.
